(19) United States
(12) Patent Application Publication
(10) Pub. No.: US 2009/0289595 A1
(43) Pub. Date: Nov. 26, 2009

(54) WIRELESS CHARGING MODULE AND ELECTRONIC APPARATUS

(75) Inventors: Chih-Jung CHEN, Taichung County (TW); Chih-Lung LIN, Tainan City (TW); Cheng-Chieh HSU, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Darfon Electronics Corp., Taoyuan (TW)

(21) Appl. No.: 12/248,265

(22) Filed: Oct. 9, 2008

(30) Foreign Application Priority Data
May 20, 2008 (TW) 97118491

(51) Int. Cl. H02J 7/00

(52) U.S. Cl. 320/108

(57) ABSTRACT

A wireless charging module includes a wireless power supplying module and a wireless receiving module. The wireless power supplying module includes a first resonator, which is for receiving first electric energy and has a first resonance frequency. The wireless receiving module includes a body, a shell, a second resonator and a charging circuit. The body is electrically connected to a battery. The second resonator is located on an inner wall of the shell and is electrically connected to the body. The second resonator has a second resonance frequency substantially the same as the first resonance frequency. The first electric energy of the first resonator is coupled to the second resonator so that non-radiative energy transfer is performed between the first and second resonators. The second resonator provides second electric energy. The charging circuit receives the second electric energy to charge the battery.

This application claims the benefit of Taiwan application Serial No. 097118491, filed May 20, 2008, the subject matter of which is incorporated herein by reference.

### BACKGROUND OF THE INVENTION

1. Field of the Invention

The invention relates in general to a wireless charging module, and more particularly to a wireless charging module for supplying energy to an electronic apparatus via energy coupling between resonators.

2. Description of the Related Art

In the modern age, in which the technology changes with each passing day, humans have used to make their life become more conveniently by widely using various electronic apparatuses. Conventionally, an electronic apparatus needs a power module to provide the electric energy required in operating the electronic apparatus. In one example, the wireless electronic apparatus is provided with a battery to power the wireless electronic apparatus. When the electric energy of the battery is used up, the user electrically connects the wireless electronic apparatus to a charger to charge the battery of the wireless electronic apparatus. For example, the charger is a transformer-rectifier circuit capable of dropping and rectifying an AC voltage on the receptacle and then generating a DC voltage.

However, when the wireless electronic apparatus is being charged, the wireless electronic apparatus needs to be electrically connected to the supplied power via the charger. Thus, the user cannot operate the wireless electronic apparatus in a wireless manner so that the convenience in using the conventional wireless electronic apparatus is low.

### SUMMARY OF THE INVENTION

The invention is directed to a wireless charging module and an electronic apparatus that can be charged via a wireless path, wherein the wireless charging module charges the electronic apparatus via energy coupling between resonators. Compared with the conventional charging module, the wireless charging module associated with the invention can charge the electronic apparatus in a wireless manner. Thus, the wireless charging module and the electronic apparatus associated with the invention have the higher convenience of use.

According to a first aspect of the present invention, a wireless charging module including a wireless power supplying module and a wireless receiving module is provided. The wireless power supplying module includes a first resonator, having a first resonance frequency, for receiving first electric energy. The wireless receiving module includes a body, a second resonator and a charging circuit. The body is electrically connected to a battery. The second resonator is electrically connected to the body and has a second resonance frequency substantially the same as the first resonance frequency. The first electric energy of the first resonator is coupled to the second resonator so that non-radiative energy transfer is performed between the first and second resonators. The second resonator provides second electric energy. The charging circuit receives the second electric energy to charge the battery.

According to a second aspect of the present invention, a wireless charging module including a wireless power supplying module and a wireless receiving module is provided. The wireless power supplying module includes a first resonator, having a first resonance frequency, for receiving first electric energy. The wireless receiving module includes a body, a shell, a second resonator and a charging circuit. The body is electrically connected to a battery. The second resonator is located on an inner wall of the shell and electrically connected to the body. The second resonator has a second resonance frequency substantially the same as the first resonance frequency. The first electric energy of the first resonator is coupled to the second resonator so that non-radiative energy transfer is performed between the first and second resonators. The second resonator provides second electric energy. The charging circuit receives the second electric energy to charge the battery.

According to a third aspect of the present invention, a wireless charging module including a wireless power supplying module, a wireless receiving module and an electronic apparatus is provided. The wireless power supplying module and the wireless receiving module respectively include a first resonator and a second resonator. The first resonator receives first electric energy and has a first resonance frequency. The second resonator has a second resonance frequency substantially the same as the first resonance frequency. The first electric energy of the first resonator is coupled to the second resonator so that non-radiative energy transfer is performed between the first and second resonators. The second resonator provides second electric energy. The electronic apparatus is separably coupled to the wireless receiving module. The electronic apparatus includes a body and a charging circuit. The body is electrically connected to a battery. The charging circuit receives the second electric energy to charge the battery.

According to a fourth aspect of the present invention, an electronic apparatus adapted to a wireless charging module is provided. The wireless charging module includes a first resonator, having a first resonance frequency, for receiving first electric energy. The electronic apparatus includes a battery, a second resonator and a charging circuit. The second resonator has a second resonance frequency substantially the same as the first resonance frequency. The first electric energy of the first resonator is coupled to the second resonator so that non-radiative energy transfer is performed between the first and second resonators. The second resonator provides second electric energy. The charging circuit receives the second electric energy to charge the battery.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a wireless charging module according to a first embodiment of the invention.

FIG. 2 is a detailed block diagram showing a wireless power supplying module 12 of FIG. 1.

FIG. 3 is a detailed block diagram showing a wireless receiving module 14 of FIG. 1.

FIG. 4 is another block diagram showing the wireless receiving module according to this embodiment of the invention.

FIG. 5A is a schematic illustration showing a wireless receiving module according to a second embodiment of the invention.

FIG. 5B is a cross-sectional view taken along a line AA′ of FIG. 5A.

FIG. 6 is a block diagram showing a wireless charging module according to a third embodiment of the invention.

FIG. 7 is a schematic illustration showing a wireless receiving module 24 and an electronic apparatus 26 according to the third embodiment of the invention.

FIG. 8 is a detailed block diagram showing the electronic apparatus 26 and the wireless receiving module 24 of FIG. 6.

FIG. 9 is a block diagram showing an electronic apparatus according to a fourth embodiment of the invention.

FIG. 10 is a detailed block diagram showing an electronic apparatus 36 of FIG. 9.

### DETAILED DESCRIPTION OF THE INVENTION

The wireless charging module of each embodiment charges an electronic apparatus via energy coupling between resonators so that the wireless charging module and the corresponding electronic apparatus of this embodiment have the higher convenience of use.

### First Embodiment

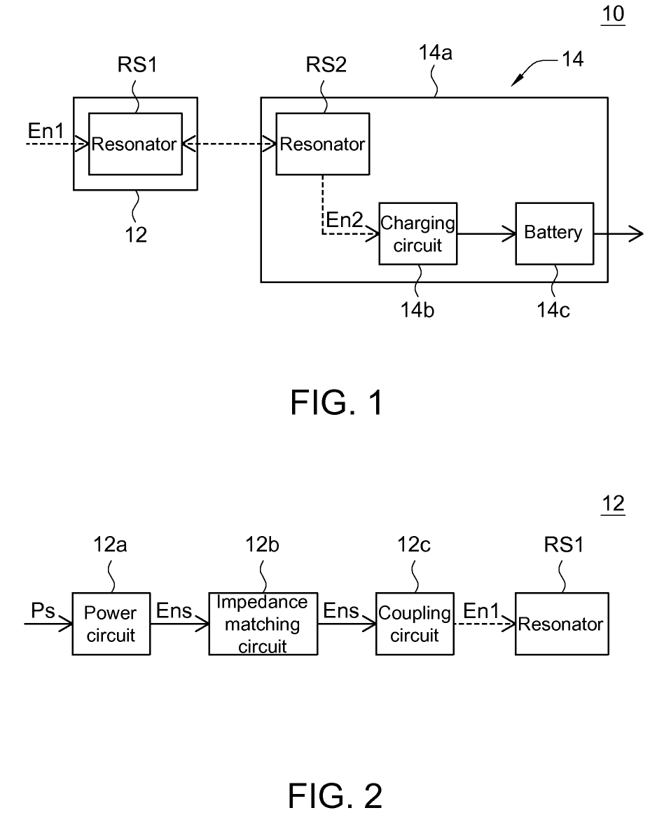

The wireless charging module of this embodiment provides electric energy to a wireless receiving module via a wireless power supplying module so as to charge a battery of the wireless receiving module in a wireless manner. FIG. 1 is a block diagram showing a wireless charging module 10 according to a first embodiment of the invention. Referring to FIG. 1, the wireless charging module 10 includes a wireless power supplying module 12 and a wireless receiving module 14. The wireless power supplying module 12 includes a resonator RS1, having a resonance frequency fo1, for receiving electric energy En1.

The wireless receiving module 14 includes a body 14a, a charging circuit 14b, a resonator RS2, and a battery 14c. The body 14a is electrically connected to the battery 14c. The resonator RS2 is electrically connected to the body 14a and has a resonance frequency fo2 substantially the same as the resonance frequency fo1. The electric energy En1 of the resonator RS1 is coupled to the resonator RS2 so that the non-radiative energy transfer is performed between the resonators RS1 and RS2. The resonator RS2 provides electric energy En2.

In this embodiment, the coupling between the resonators RS1 and RS2 corresponds to a coupling coefficient K. The coupling coefficient K relates to an energy transfer ratio between the resonators RS1 and RS2. For example the coupling coefficient K satisfies:

$$K = \frac{M}{\sqrt{L 1 \times L 2}} ,$$

wherein M is a mutual inductance value between the resonators RS1 and RS2, and L1 and L2 are respectively self inductance values of the resonators RS1 and RS2.

In one example, the wireless power supplying module 12 further includes a power circuit 12a, an impedance matching circuit 12b, and a coupling circuit 12c. FIG. 2 is a detailed block diagram showing the wireless power supplying module 12 of FIG. 1. The power circuit 12a provides the electric energy Ens. In this embodiment, for example, the power circuit 12a is a transmission interface circuit, which is to be connected to a computer system (not shown), receives the power Ps provided by the computer system, and generates the electric energy Ens by transforming the power Ps.

For example, the power circuit 12a includes a universal serial bus (USB) device controller, which is connected to the computer system via the USB and receives the power Ps provided by the computer system. The power Ps is the DC power, for example. The power circuit 12a further includes, for example, an oscillator, an inverter or a DC/AC converter for generating the AC electric energy Ens according to the power Ps.

The impedance matching circuit 12b receives and outputs the electric energy Ens. The coupling circuit 12c receives the electric energy Ens outputted from the impedance matching circuit 12b, and the energy of the coupling circuit 12c is further coupled to a resonator RS1 so that the electric energy En1 is provided to the resonator RS1.

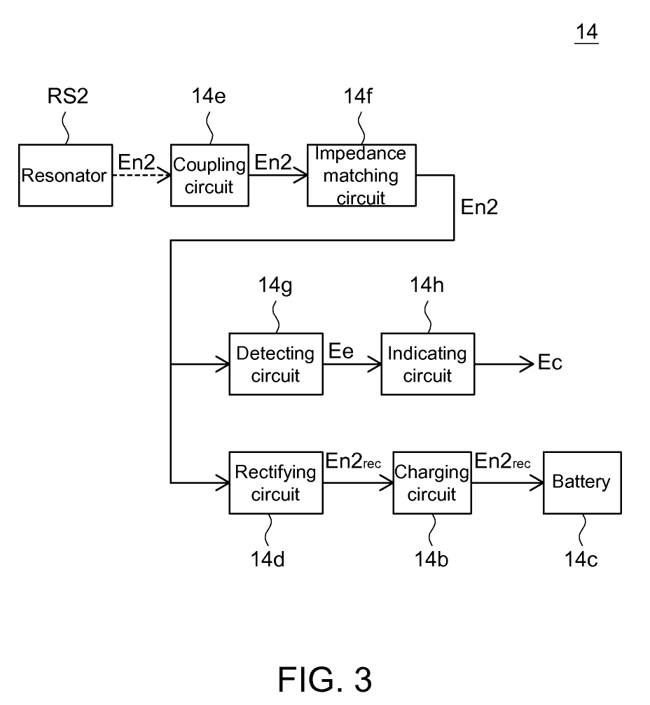

In one example, the wireless receiving module 14 further includes a rectifying circuit 14d, a coupling circuit 14e and an impedance matching circuit 14f. FIG. 3 is a detailed block diagram showing the wireless receiving module 14 of FIG. 1. As shown in FIG. 3, the energy on a resonator RS2 is coupled to the coupling circuit 14e so that the coupling circuit 14e receives the electric energy En2. The impedance matching circuit 14f receives and outputs the electric energy En2. The rectifying circuit 14d receives and rectifies the electric energy En2 provided by the impedance matching circuit 14f so as to provide the rectified electric energy En2_{rec}. The charging circuit 14b charges the battery 14c in response to the rectified electric energy En2_{rec}. Thus, the wireless power supplying module 12 in the wireless charging module 10 can charge the battery 14c of the wireless receiving module 14 in a wireless manner.

The wireless receiving module 14 further includes a detecting circuit 14g and an indicating circuit 14h. The detecting circuit 14g receives the electric energy En2, determines a coupling amount between the resonators RS1 and RS2 according to the electric energy En2, and triggers a circuit operation event Ee when the coupling amount between the resonators RS1 and RS2 is substantially higher than a threshold value. The indicating circuit 14h triggers an indicating charge event Ec in response to the circuit operation event Ee.

For example, the indicating circuit 14h includes a control circuit (not shown) and a lighting element (not shown). The control circuit enables the lighting element to emit light in response to the circuit operation event Ee and thus generates the indicating charge event Ec. Thus, the user can obtain whether or not the wireless power supplying module 12 can effectively charge the battery 14c according to whether or not the lighting element emits the light.

In this illustrated embodiment, the indicating circuit 14h includes the lighting element for emitting the light to generate the charge event Ec. However, the indicating circuit 14h of this embodiment is not limited to the inclusion of the lighting element. For example, the indicating circuit 14h of this embodiment may include a sounding element for sounding or a vibrating element for vibrating to generate the indicating charge event Ec.

The wireless charging module 10 of this embodiment is used in an electronic apparatus to provide the electric energy for operating the electronic apparatus. Generally speaking, the electronic apparatus has an input device for correspondingly generating user interface operation information in response to a user input event. For example, the electronic apparatus may be a notebook computer, a personal digital assistant (PDA), a cell telephone or a digital camera. In this embodiment, the electronic apparatus receives the electric energy of the battery 14c to operate.

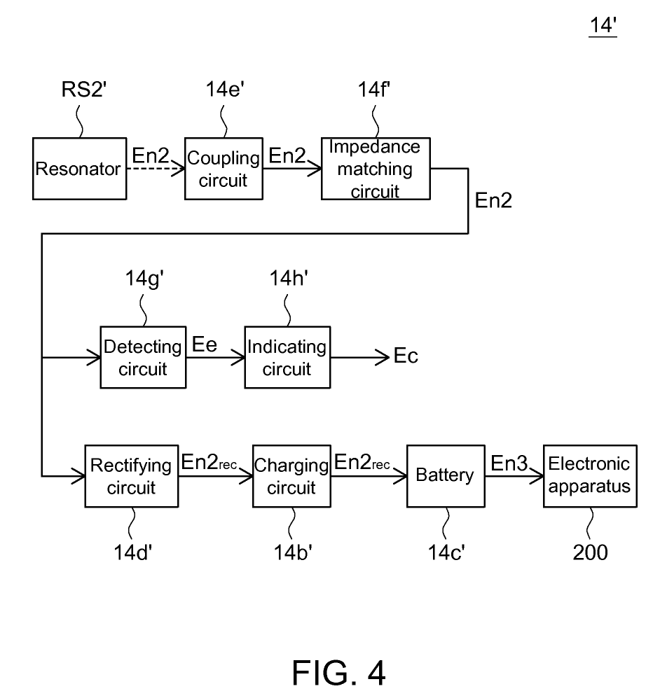

In one application example, circuits associated with an electronic apparatus 100 are integrated in the wireless receiving module 14 of the wireless charging module 10. FIG. 4 is another block diagram showing the wireless receiving module according to this embodiment of the invention. As shown in FIG. 4, for example, an electronic apparatus 200 is a system on chip (SOC) integrated in the wireless receiving module 14′ to receive the electric energy En3 provided by the battery 14c′ to perform the corresponding operation.

The wireless power supplying module of the wireless mouse module and the mouse device of this embodiment respectively have the first and second resonators. The energy between the first and second resonators is coupled to each other so that the wireless power supplying module can provide the energy to charge the battery in the mouse device. Thus, compared with the conventional wireless mouse, the wireless mouse module of this embodiment can charge the wireless mouse in a wireless manner so that the wireless mouse module of this embodiment has the higher convenience of use.

### Second Embodiment

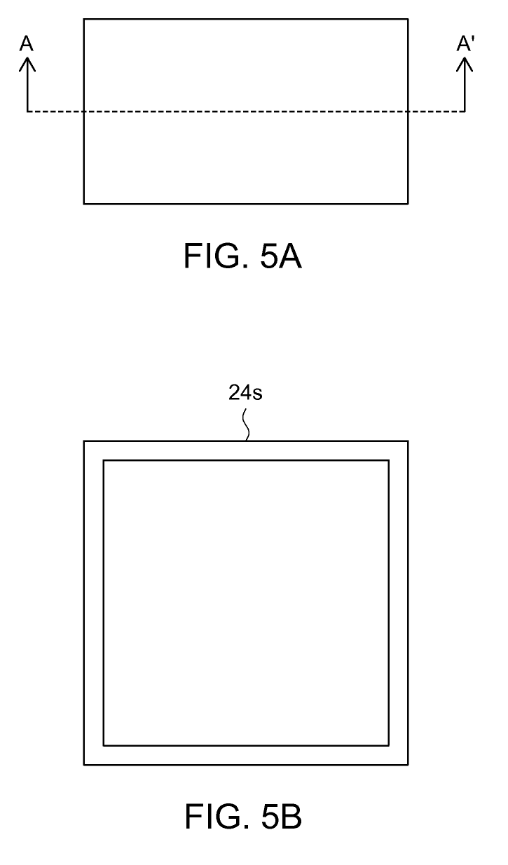

The wireless receiving module of the wireless charging module according to this embodiment includes a shell, and the resonator of the wireless receiving module is located on an inner wall of the shell. FIG. 5A is a schematic illustration showing a wireless receiving module 24 according to a second embodiment of the invention. FIG. 5B is a cross-sectional view taken along a line AA′ of FIG. 5A. Referring to FIGS. 5A and 5B, the difference between the wireless receiving module 24 of this embodiment and the wireless receiving module 14 of the first embodiment is that the wireless receiving module 24 of this embodiment further has a shell 24s, and the resonator located inside the wireless receiving module 24 is a solenoid conductor coil.

The coil in the solenoid conductor coil is located on the inner wall of the shell 24s in a manner of surrounding the inner wall of the shell 24s. More specifically, the solenoid conductor coil includes multiple coil bodies. The inner wall of the shell 24s has a maximum cross-sectional area, and one of the coil bodies is located on the inner wall in a manner of surrounding an outer edge of the maximum cross-sectional area.

### Third Embodiment

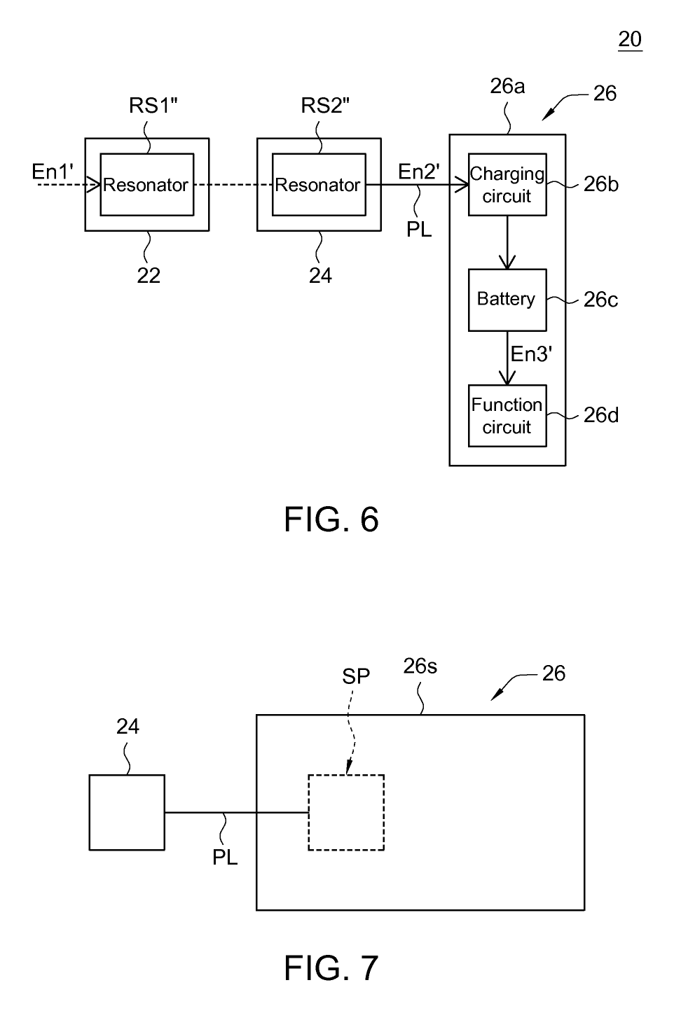

The wireless charging module of this embodiment includes an electronic apparatus, which may be disposed in a manner separable from the wireless receiving module of the wireless charging module. The wireless power supplying module of the wireless charging module provides the electric energy to drive the electronic apparatus via the wireless receiving module. FIG. 6 is a block diagram showing a wireless charging module 20 according to a third embodiment of the invention. As shown in FIG. 6, the difference between the wireless charging module 20 of this embodiment and the wireless charging module 10 of the first embodiment is that the wireless charging module 20 further includes an electronic apparatus 26, which may be disposed in a manner separable from the wireless receiving module 24. The electronic apparatus 26 is connected to the wireless receiving module 24 via a power line PL.

The electronic apparatus 26 includes a body 26a, a charging circuit 26b, a battery 26c, and a function circuit 26d. The charging circuit 26b performs the operations similar to those of the charging circuit 14b of the first embodiment, and provides the electric energy En2′ to charge the battery 26c. The function circuit 26d is, for example, a core processing circuit of the electronic apparatus 26, and performs the operations associated with the electronic apparatus 26 according to the electric energy En3′ provided by the battery 26c.

FIG. 7 is a schematic illustration showing the wireless receiving module 24 and the electronic apparatus 26 according to the third embodiment of the invention. Referring to FIG. 7, the electronic apparatus 26 of this embodiment further has a shell 26s and a transmission cable PL, for example, wherein the charging circuit 26b, the battery 26c and the function circuit 26d are located in the shell 26s. The outer surface of the shell 26s further has a chamber SP for selectively accommodating the wireless receiving module 24. The charging circuit 26b is electrically connected to the wireless receiving module 24 via the power line PL and thus receives the energy En2′ coupled from a resonator RS1″ of a wireless power supplying module 22 to a resonator RS2″ of the wireless receiving module 24.

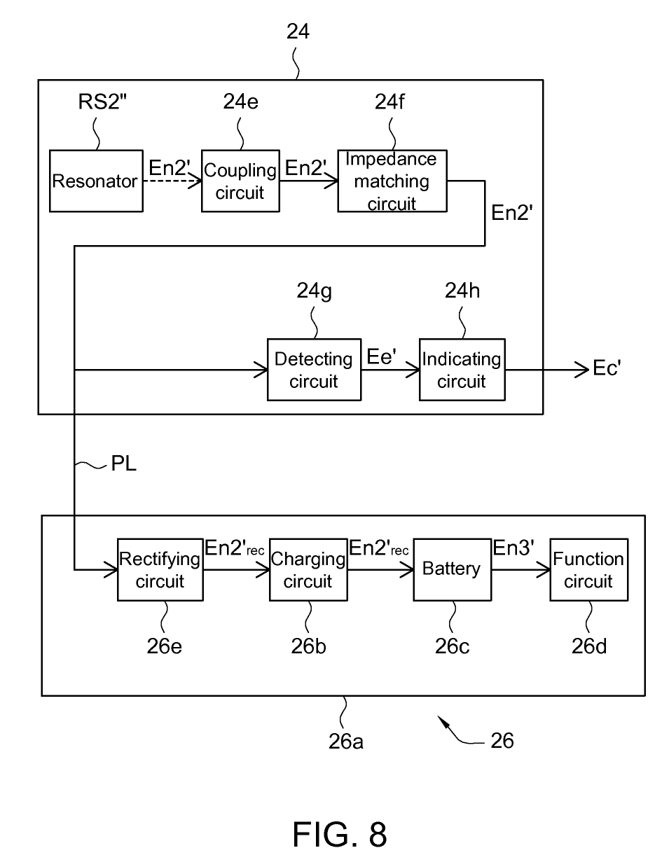

FIG. 8 is a detailed block diagram showing the electronic apparatus 26 and the wireless receiving module 24 of FIG. 6. More specifically, the wireless receiving module 24 further includes a coupling circuit 24e and an impedance matching circuit 24f, which operate in manners similar to those of the coupling circuit 14e and the impedance matching circuit 14f of FIG. 3. The wireless receiving module 24 further includes a detecting circuit 24g and an indicating circuit 24h. The detecting circuit 24g and the indicating circuit 24h respectively perform the operations, which are similar to those of the detecting circuit 14g and the indicating circuit 14h of the wireless charging module 10, to respectively judge whether or not the energy En2′ exceeds the threshold value, and generate the indicating charge event Ec′ in response to the circuit operation event Ee′ triggered in the detecting circuit 24g.

The electronic apparatus 26 further includes a rectifying circuit 26e, which performs the operations similar to those of the rectifying circuit 14d of FIG. 3 to rectify the energy En2′ and thus generate the rectified energy En2′_{rec}. The charging circuit 26b charges the battery 26c according to the rectified energy En2′_{rec}, for example.

The wireless charging module of this embodiment includes the wireless power supplying module and the wireless receiving module, which respectively have the first and second resonators. The energy between the first and second resonators is coupled to each other so that the wireless power supplying module can provide the energy to the wireless receiving module. The electronic apparatus charges the battery according to the energy received by the wireless receiving module. Thus, compared with the conventional charging module, the wireless charging module of this embodiment can charge the electronic apparatus in a wireless manner so that the electronic apparatus of this embodiment has the higher convenience of use.

### Fourth Embodiment

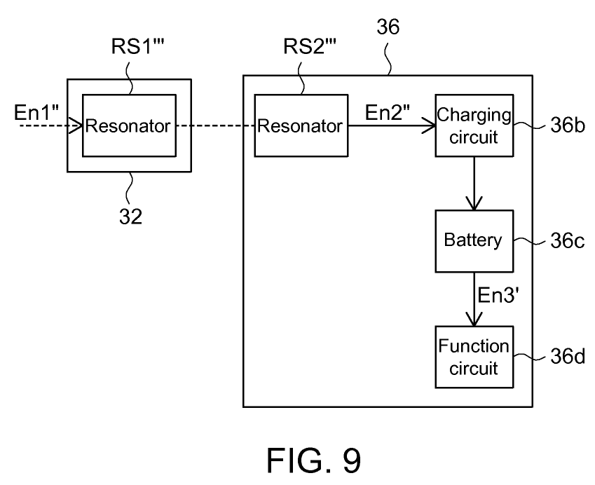

The electronic apparatus of this embodiment operates according to the electric energy provided by the wireless charging module in a wireless manner. FIG. 9 is a block diagram showing an electronic apparatus 36 according to a fourth embodiment of the invention. As shown in FIG. 9, the difference between the electronic apparatus 36 of this embodiment and the electronic apparatus of the third embodiment is that the electronic apparatus 36 further includes a resonator RS2′″, wherein the electric energy on the resonator RS1′″ of a wireless power supplying module 32 is coupled to the resonator RS2′″ to provide the electric energy En2″ to the electronic apparatus 36.

The electronic apparatus 36 further includes a charging circuit 36b, a battery 36c, and a function circuit 36d for performing the operations similar to those of the charging circuit 26b, the battery 26c and the function circuit 26d of FIG. 6.

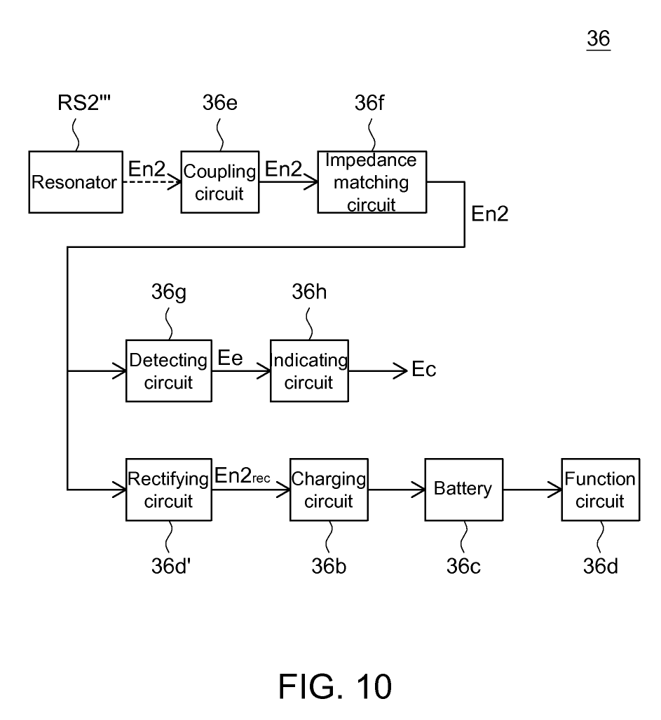

FIG. 10 is a detailed block diagram showing the electronic apparatus 36 of FIG. 9. In one example, as shown in FIG. 10, the electronic apparatus 36 further includes a coupling circuit 36e, an impedance circuit 36f, a detecting circuit 36g, an indicating circuit 36h, and a rectifying circuit 36d′, wherein the circuits respectively perform the operations similar to those of the corresponding circuits of FIG. 3.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless charging module, comprising:
a wireless power supplying module, which comprises:
a first resonator, having a first resonance frequency, for receiving first electric energy; and
a wireless receiving module, which comprises:
a body electrically connected to a battery;
a second resonator electrically connected to the body and having a second resonance frequency substantially the same as the first resonance frequency, wherein the first electric energy of the first resonator is coupled to the second resonator so that non-radiative energy transfer is performed between the first resonator and the second resonator, and the second resonator provides second electric energy; and
a charging circuit for receiving the second electric energy to charge the battery.

2. The wireless charging module according to claim 1, wherein the wireless power supplying module further comprises:
a power circuit for providing power;
an impedance matching circuit for receiving and outputting the power; and
a first coupling circuit for receiving the power outputted from the impedance matching circuit, wherein energy of the first coupling circuit is further coupled to the first resonator to provide the first electric energy to the first resonator.

3. The wireless charging module according to claim 2, wherein the power circuit further receives power provided by a computer system via a transmission interface.

4. The wireless charging module according to claim 1, further comprising:
a detecting circuit for determining a coupling amount between the first resonator and the second resonator according to the second electric energy, and triggering a circuit operation event when the coupling amount between the first resonator and the second resonator is substantially higher than a threshold value; and
an indicating circuit for triggering an indicating charge event in response to the circuit operation event.

5. The wireless charging module according to claim 4, wherein the wireless receiving module further comprises:
a second coupling circuit, wherein energy of the second resonator is coupled to the second coupling circuit so that the second coupling circuit receives the second electric energy; and
an impedance matching circuit for receiving and outputting the second electric energy to the detecting circuit.

6. The wireless charging module according to claim 5, wherein the wireless receiving module further comprises:
a rectifying circuit for receiving and rectifying the second electric energy provided by the impedance matching circuit, and providing the rectified second electric energy, wherein the charging circuit further receives the rectified second electric energy to charge the battery.

7. The wireless charging module according to claim 4, wherein the indicating circuit comprises a control circuit and a lighting element, and the control circuit enables the lighting element to emit light and thus generate the indicating charge event in response to the circuit operation event.

8. The wireless charging module according to claim 4, wherein the indicating circuit comprises a control circuit and a sounding element, and the control circuit enables the sounding element to sound and thus generate the indicating charge event in response to the circuit operation event.

9. The wireless charging module according to claim 4, wherein the indicating circuit comprises a control circuit and a vibrating element, and the control circuit enables the vibrating element to vibrate and thus to generate the indicating charge event in response to the circuit operation event.

10. The wireless charging module according to claim 1, wherein the wireless receiving module comprises an electronic apparatus.

11. The wireless charging module according to claim 10, wherein the electronic apparatus comprises an input device.

12. The wireless charging module according to claim 11, wherein the input device comprises a keyboard or a mouse.

13. A wireless charging module, comprising:
a wireless power supplying module, which comprises:
a first resonator, having a first resonance frequency, for receiving first electric energy; and
a wireless receiving module, which comprises:
a body electrically connected to a battery;
a shell;
a second resonator located on an inner wall of the shell and electrically connected to the body, wherein the second resonator has a second resonance frequency substantially the same as the first resonance frequency, the first electric energy of the first resonator is coupled to the second resonator so that non-radiative energy transfer is performed between the first resonator and the second resonator, and the second resonator provides second electric energy; and
a charging circuit for receiving the second electric energy to charge the battery.

14. The wireless charging module according to claim 13, wherein the second resonator comprises a coil located on the inner wall in a manner of surrounding the inner wall of the shell.

15. The wireless charging module according to claim 14, wherein the coil comprises a plurality of coil bodies, the inner wall has a maximum cross-sectional area, the coil bodies are located on the inner wall in a manner of surrounding an outer edge of the maximum cross-sectional area.

16. The wireless charging module according to claim 13, wherein the wireless power supplying module further comprises:
a power circuit for providing power;
an impedance matching circuit for receiving and outputting the power; and
a first coupling circuit for receiving the power outputted from the impedance matching circuit, wherein energy of the first coupling circuit is further coupled to the first resonator to provide the first electric energy to the first resonator.

17. The wireless charging module according to claim 16, wherein the power circuit further receives power provided by a computer system via a transmission interface.

18. The wireless charging module according to claim 13, wherein the wireless receiving module further comprises:
a detecting circuit, coupled to the second resonator, for determining a coupling amount between the first resonator and the second resonator according to the second electric energy, and triggering a circuit operation event when the coupling amount between the first resonator and the second resonator is substantially higher than a threshold value; and
an indicating circuit for triggering an indicating charge event in response to the circuit operation event.

19. The wireless charging module according to claim 18, wherein the wireless receiving module further comprises:
a second coupling circuit, wherein energy of the second resonator is coupled to the second coupling circuit so that the second coupling circuit receives the second electric energy; and
an impedance matching circuit for receiving and outputting the second electric energy to the detecting circuit.

20. The wireless charging module according to claim 19, wherein the wireless receiving module further comprises:
a rectifying circuit for receiving and rectifying the second electric energy provided by the impedance matching circuit, and providing the rectified second electric energy, wherein the charging circuit further receives the rectified second electric energy to charge the battery.

21. The wireless charging module according to claim 18, wherein the indicating circuit comprises a control circuit and a lighting element, and the control circuit enables the lighting element to emit light and thus generate the indicating charge event in response to the circuit operation event.

22. The wireless charging module according to claim 18, wherein the indicating circuit comprises a control circuit and a sounding element, and the control circuit enables the sounding element to sound and thus generate the indicating charge event in response to the circuit operation event.

23. The wireless charging module according to claim 18, wherein the indicating circuit comprises a control circuit and a vibrating element, and the control circuit enables the vibrating element to vibrate and thus to generate the indicating charge event in response to the circuit operation event.

24. A wireless charging module, comprising:
a wireless power supplying module and a wireless receiving module, which respectively comprise:
a first resonator, having a first resonance frequency, for receiving first electric energy; and
a second resonator having a second resonance frequency substantially the same as the first resonance frequency, wherein the first electric energy of the first resonator is coupled to the second resonator so that non-radiative energy transfer is performed between the first resonator and the second resonator, and the second resonator provides second electric energy; and
an electronic apparatus separably coupled to the wireless receiving module, the electronic apparatus comprising:
a body electrically connected to a battery; and
a charging circuit for receiving the second electric energy to charge the battery.

25. The wireless charging module according to claim 24, wherein the electronic apparatus further has a shell and a transmission cable, the body and the charging circuit are located in the shell, an outer surface of the shell has a chamber for selectively accommodating the wireless receiving module, and the charging circuit is electrically connected to the wireless receiving module via the transmission cable.

26. The wireless charging module according to claim 24, wherein the wireless power supplying module further comprises:
a power circuit for providing power;
an impedance matching circuit for receiving and outputting the power; and
a first coupling circuit for receiving the power outputted from the impedance matching circuit, wherein energy of the first coupling circuit is further coupled to the first resonator to provide the first electric energy to the first resonator.

27. The wireless charging module according to claim 26, wherein the power circuit further receives power provided by a computer system via a transmission interface.

28. The wireless charging module according to claim 24, wherein the wireless receiving module further comprises:
a detecting circuit for determining a coupling amount between the first resonator and the second resonator in response to the second electric energy and triggering a circuit operation event when the coupling amount between the first resonator and the second resonator is substantially higher than a threshold value; and
an indicating circuit for triggering an indicating charge event in response to the circuit operation event.

29. The wireless charging module according to claim 28, wherein the wireless receiving module further comprises:
a second coupling circuit, wherein energy of the second resonator is coupled to the second coupling circuit so that the second coupling circuit receives the second electric energy; and
an impedance matching circuit for receiving and outputting the second electric energy to the detecting circuit.

30. The wireless charging module according to claim 29, wherein the electronic apparatus further comprises:
a rectifying circuit for receiving and rectifying the second electric energy provided by the impedance matching circuit, and providing the rectified second electric energy, wherein the charging circuit further receives the rectified second electric energy to charge the battery.

31. The wireless charging module according to claim 28, wherein the indicating circuit comprises a control circuit and a lighting element, and the control circuit enables the lighting element to emit light and thus generate the indicating charge event in response to the circuit operation event.

32. The wireless charging module according to claim 28, wherein the indicating circuit comprises a control circuit and a sounding element, and the control circuit enables the sounding element to sound and thus generate the indicating charge event in response to the circuit operation event.

33. The wireless charging module according to claim 28, wherein the indicating circuit comprises a control circuit and a vibrating element, and the control circuit enables the vibrating element to vibrate and thus to generate the indicating charge event in response to the circuit operation event.

34. An electronic apparatus adapted to a wireless charging module, the wireless charging module comprising a first resonator for receiving first electric energy, the first resonator having a first resonance frequency, the electronic apparatus comprising:
a battery;
a second resonator having a second resonance frequency substantially the same as the first resonance frequency, wherein the first electric energy of the first resonator is coupled to the second resonator so that non-radiative energy transfer is performed between the first resonator and the second resonator, and the second resonator provides second electric energy; and
a charging circuit for receiving the second electric energy to charge the battery.

35. The electronic apparatus according to claim 34, wherein the wireless charging module further comprises:
a power circuit for providing power;
an impedance matching circuit for receiving and outputting the power; and
a first coupling circuit for receiving the power outputted from the impedance matching circuit, wherein energy of the first coupling circuit is further coupled to the first resonator to provide the first electric energy to the first resonator.

36. The electronic apparatus according to claim 34, further comprising:
a detecting circuit, coupled to the second resonator, for determining a coupling amount between the first resonator and the second resonator according to the second electric energy, and triggering a circuit operation event when the coupling amount between the first resonator and the second resonator is substantially higher than a threshold value; and
an indicating circuit for triggering an indicating charge event in response to the circuit operation event.

37. The electronic apparatus according to claim 36, further comprising:
a second coupling circuit, wherein energy of the second resonator is coupled to the second coupling circuit so that the second coupling circuit receives the second electric energy; and
an impedance matching circuit for receiving and outputting the second electric energy to the detecting circuit.

38. The electronic apparatus according to claim 37, further comprising:
a rectifying circuit for receiving and rectifying the second electric energy provided by the impedance matching circuit, and providing the rectified second electric energy, wherein the charging circuit further receives the rectified second electric energy to charge the battery.

39. The electronic apparatus according to claim 36, wherein the indicating circuit comprises a control circuit and a lighting element, and the control circuit enables the lighting element to emit light and thus generate the indicating charge event in response to the circuit operation event.

40. The electronic apparatus according to claim 36, wherein the indicating circuit comprises a control circuit and a sounding element, and the control circuit enables the sounding element to sound and thus generate the indicating charge event in response to the circuit operation event.

41. The electronic apparatus according to claim 36, wherein the indicating circuit comprises a control circuit and a vibrating element, and the control circuit enables the vibrating element to vibrate and thus to generate the indicating charge event in response to the circuit operation event.

42. The wireless charging module according to claim 30, wherein the electronic apparatus comprises an input device.
